(19) United States
(12) Patent Application Publication
(10) Pub. No.: US 2018/0082544 A1
(43) Pub. Date: Mar. 22, 2018

(54) Social Gaming System

(71) Applicant: Eric Simon, Summit, NJ (US)

(72) Inventor: Eric Simon, Summit, NJ (US)

(73) Assignee: Raewood Entertainment, LLC, Summit, NJ (US)

(21) Appl. No.: 15/705,499

(22) Filed: Sep. 15, 2017

Related U.S. Application Data
(60) Provisional application No. 62/397,035, filed on Sep. 20, 2016.

(51) Int. Cl. G07F 17/32

(52) U.S. Cl. CPC G07F 17/3295; G07F 17/3255; A63F 2300/8064; G07F 17/323; G07F 17/3272; G07F 17/3218

(57) ABSTRACT

The present invention is a method of conducting a game among multiple participants by means of application software operating on or accessed through the participants' respective mobile devices. The mobile app or mobile SaaS connects the participating mobile devices via the internet with a game server, which provides a daily menu of predictive questions organized in multiple categories. Exemplary question categories can include, without limitation, sporting events, weather, entertainment, food, financial markets, and social media. Each question must relate to an outcome to be realized within the day the question is posed, and each question must have a time deadline for responding to the question before the outcome will become known.

### REFERENCE TO RELATED APPLICATION

This application claims the benefit of the filing date of U.S. Provisional Patent Application No. 62/397,035, filed Sep. 20, 2016, which is incorporated herein by reference.

### FIELD OF INVENTION

The present invention relates to the general field of game application software (“apps”) designed for mobile devices, such as wireless phones and tablet computers, and more particularly to mobile apps for predictive games with e-commerce and/or social media based reward components. Some embodiments of the present invention also relate to the field of game software which is centrally hosted and is deployed, delivered and accessed in a Software as a Service (SaaS) model.

### BACKGROUND OF THE INVENTION

Apart from their original telephone functions, mobile devices increasingly serve purposes related to information, entertainment, shopping and social interaction. While various mobile apps are available in each of these categories, what is lacking is a single app that combines all of these functions synergistically, so that each separate function promotes and enhances the others. Such a synergism is achieved in the present invention by providing mobile social gaming app, which integrates social media activity with reward-based predictive and e-commerce components. The mobile social gaming app of the present invention can be implemented either as a downloadable stand-alone mobile app or as a centrally hosted mobile SaaS licensed on a subscription basis and accessed through a web browser.

### SUMMARY OF THE INVENTION

The present invention is a method of conducting a game among multiple participants by means of application software operating on the participants' respective mobile devices, either as a downloadable stand-alone mobile app or as a centrally hosted mobile SaaS. The mobile app or SaaS connects the participating mobile devices via the internet with a game server, which provides a daily menu of predictive questions organized in multiple categories. Exemplary question categories can include, without limitation, sporting events, weather, entertainment, food, financial markets, and social media.

Each question must relate to an outcome to be realized within the day the question is posed, and each question must have a time deadline for responding to the question before the outcome will become known. For example, a “Daily Matchup” question could require a prediction of the number of homeruns to be hit in a baseball game to be played that day, with the question deadline set just before game time. Daily matchup questions can be sponsored by businesses involved in the e-commerce component of the game.

In one embodiment of the game, each participant can select five questions each day from the Daily Matchups menu of 20 questions, and he/she is awarded one reward point for each correct answer. Optionally, there can be one or more “featured” daily matchup questions, for which bonus points are awarded. Additional reward points can be earned in a daily trivia contest, for example, consisting of ten questions that the participant must answer within one minute. A reward point is awarded for every three correct trivia answers. If the participant gets at least one correct trivia answer, he/she will have the option of buying back another ten questions for a specified cost, which may be monetary or based on accumulated reward points. A similar buy-back option can also be offered for the daily matchup questions.

An e-commerce component of the game handles transactions involving participants' reward points, including redemption of points for specific rewards, as well as in participant's “buy back” payments for additional trivia questions. Reward points can be redeemed instantly in exchange for various digital downloads, including music, movies and games. Instant point redemption is also feasible in exchange for gift/credit cards. For product rewards, such as clothing and electronics, a third-party fulfillment service can be provided.

The game also features a players' “leader board” component, in which all participants are ranked according to their accumulated reward points. Groups of participants can also form private leagues, in which they compete against each other. Bonus points are awarded to the highest-ranking players. Additional bonus points can be earned through brand sponsoring of individual players and/or leagues. Such bonus points are linked to the e-commerce game component, and they can also be linked to a player's social media activity advertising the sponsorship.

The game's social media components include a list showing the most trending content posted by the game's players on social media. If the name of the game is “Trenzr”, for example, the social media features could be called “#What's Trenzing”. Optionally, in addition to a players' leader board, there can also be a social media leader board, in which players are ranked according to the number of their social media postings referring to the game and/or their e-commerce sponsorship. If the name of the game is Trenzr™, for example, social media bonus points can be awarded to the players with the most postings using the hashtag #Trenzr.

The synergy between the social media, e-commerce and bonus point components is an important and distinguishing aspect of this game. The game incentivizes players' social media activity, which promotes the game and increases the value of its e-commerce component, thereby attracting corporate sponsorship and involvement of third-party fulfillment services.

Each participant will have an individual profile page, which will list their personal data, social media links, reward points, leader board rankings, redeemed gifts, and “badges” awarded for achieving specified point levels. Participants can opt to share certain profile data with all participants, but to limit access to other profile data based on permissions or “friending.”

In the SaaS embodiments of the game, multiple game contest components and question categories are stored, so that each game subscription can customize the game to the subscriber's particular needs and preference. The SaaS customization options also enable the subscriber to tailor the look-and-feel of the game to incorporate and promote the subscriber's brand. SaaS customization also enables the subscriber to configure the e-commerce component of the game to promote its own brand, products and/or services.

For example, a professional baseball team could customize the game to limit predictive questions to scores and statistics relating to upcoming major league baseball games and select trivia contest categories relating to baseball trivia. In this example, the appearance of the game could include the team colors and logo, and reward points could be redeemable for game tickets and team memorabilia.

The foregoing summarizes the general design features of the present invention. In the following sections, specific embodiments of the present invention will be described in some detail. These specific embodiments are intended to demonstrate the feasibility of implementing the present invention in accordance with the general design features discussed above. Therefore, the detailed descriptions of these embodiments are offered for illustrative and exemplary purposes only, and they are not intended to limit the scope either of the foregoing summary description or of the claims which follow.

### BRIEF DESCRIPTION OF THE DRAWINGS

FIG. 1 is a schematic diagram of an exemplary communication system for implementing the present invention;

FIG. 2 is an exemplary flowchart illustrating a method of playing a game according to one embodiment of the present invention;

FIG. 3 is an exemplary menu screen for a mobile app according to one embodiment of the present invention;

FIG. 4A is an exemplary screen for a “daily matchup” question, according to one embodiment of the present invention;

FIG. 4B is an exemplary screen for the creation of a “daily matchup” question by a game participant, according to one embodiment of the present invention;

FIGS. 5A-5C are exemplary screens for trivia tests and associated reward points, according to one embodiment of the present invention;

FIGS. 6A and 6B are exemplary screens for participants' statistics and leader board, according to one embodiment of the present invention; and

FIG. 7 is an exemplary screen for a participant's profile and rewards, according to one embodiment of the present invention.

### DETAILED DESCRIPTION OF THE PREFERRED EMBODIMENT

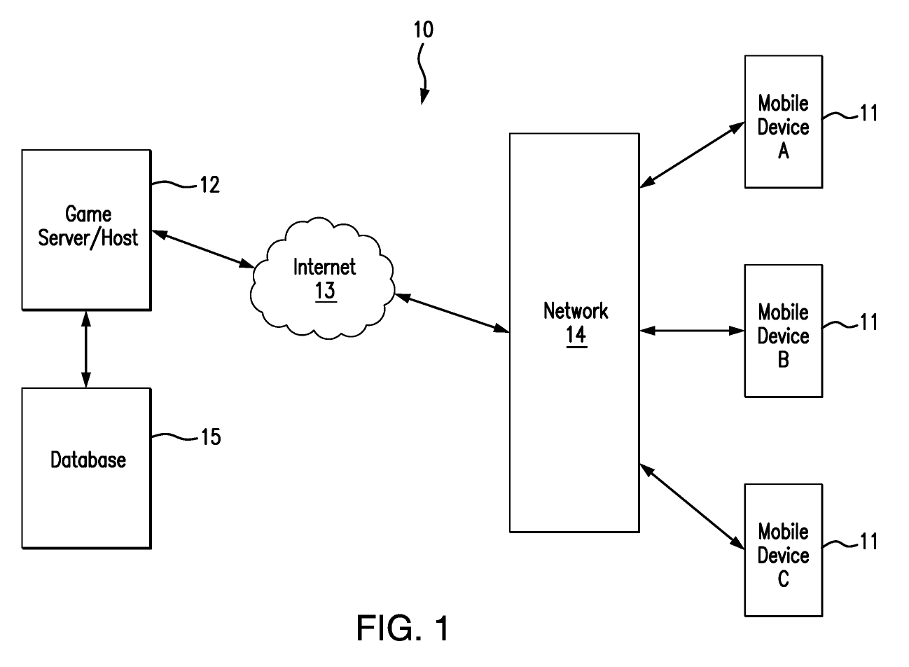

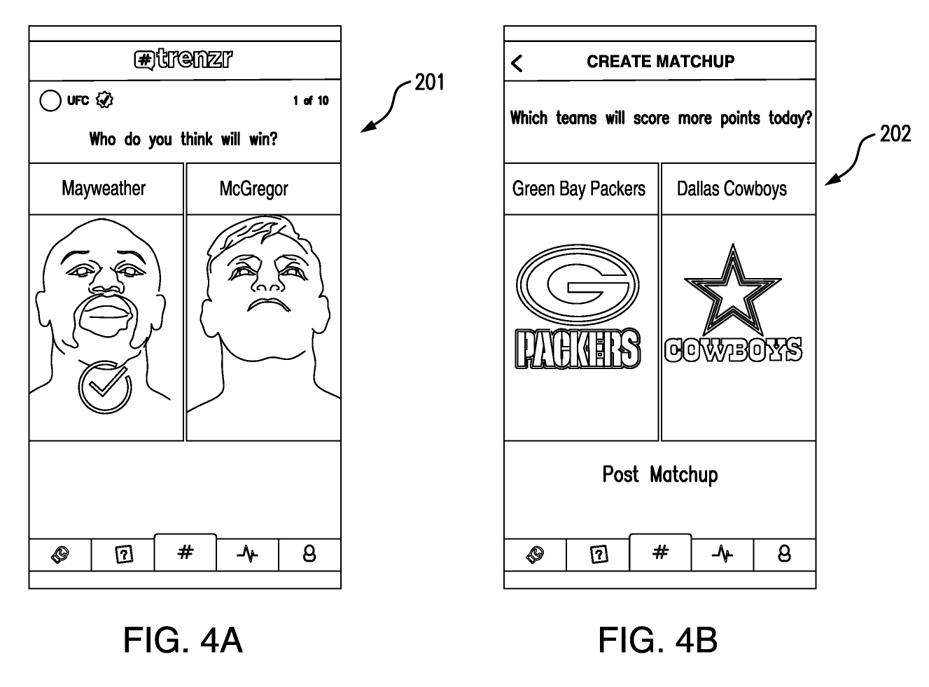

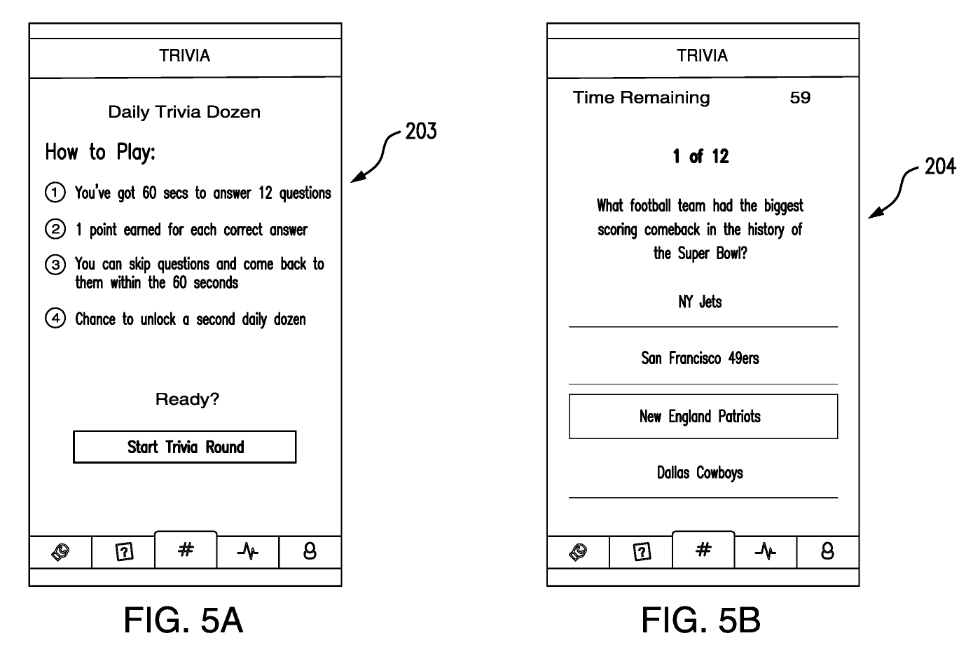

FIG. 1 illustrates the basic communication system 10 on which a social gaming system according to the present invention operates. In the stand-alone app, multiple game participants will download the game app to their respective mobile devices 11 from an administered game server 12 via the internet 13, to which their mobile devices connect through a communications network 14. In the SaaS version, multiple game participants will connect via the web browsers of their mobile devices 11 through the communications network 14 to an internet site 13 in which is embedded a link to the central game host 12. The game server/host 12 stores game data, including player profiles, in a database 15, which can also be the source of questions for the game's trivia component. Data for daily matchup questions and answers can be extracted from internet websites 13 by the game server 12. Optionally, game participants can submit suggested daily matchup questions to the administrator(s) of the game server and earn bonus points if their suggestions are used. FIG. 4B depicts an exemplary daily matchup question 202 created by a game participant.

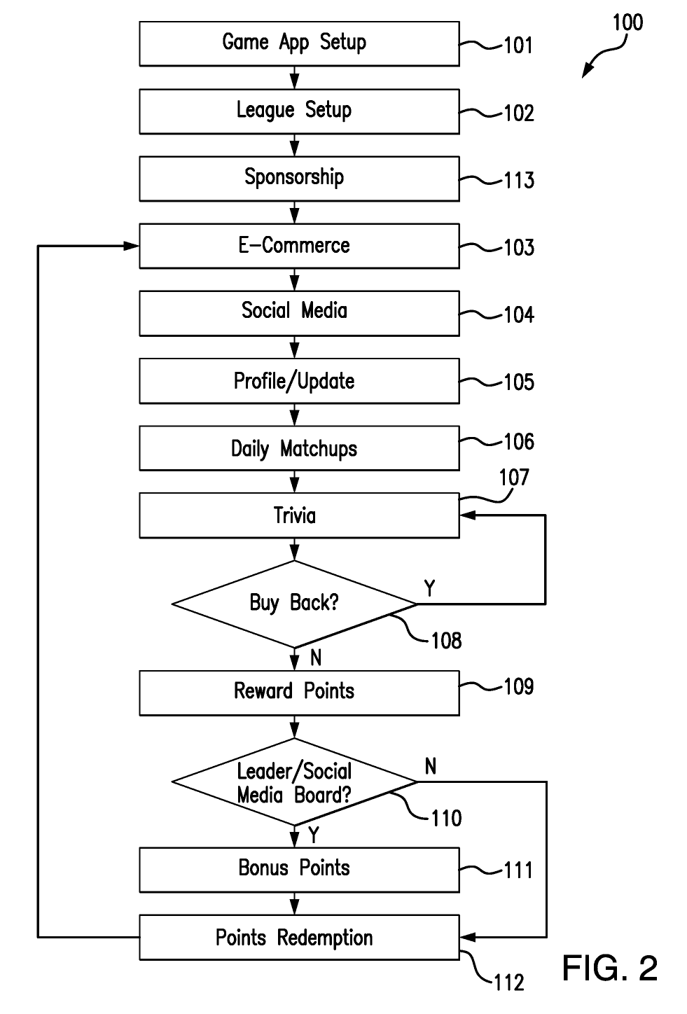

FIG. 2 is an exemplary flowchart illustrating how a social media based game can be played according to one embodiment of the present invention 100. First, the game app is downloaded to the player's mobile device in the stand-alone version, or accessed from the centrally hosted website 12 in the SaaS version. A setup protocol 101 is followed, during which the player creates an account, inputs a user name, password and enters basic profile data. If the player is part of a group that seeks to form a private league, a supplemental league setup protocol 102 is followed.

Next the app or SaaS will prompt the player to elect to apply for sponsorship 113 by one or more of the game's e-commerce vendors 103. The sponsorship 113 may involve the player's commitment to publicize the vendor's products using the game's social media links 104, for which the sponsored player can be awarded bonus points paid for or subsidized by the sponsoring vendor.

The player will then be prompted to update his/her profile page to incorporate new data regarding sponsorship, league participation, etc. 105. At this point, the player is ready to access the list of daily matchups 106 provided by the game server 12. In this embodiment, the player selects five questions from a list of twenty questions in various categories, for example:

Q1: How many points will Apple stock gain or lose today?

Q2: How many runs will the N.Y. Mets score today?

Q3: Which Broadway show will sell the most tickets today?

Q4: Which U.S. city will have the highest rainfall today?

Q5: What TV show will have the highest viewer ratings today?

Some questions on the daily matchup list 106 will “close” at certain times during the day.

For example, Q1 may close three hours before the stock market's closing bell, while Q2 may close just before game time. FIG. 4A depicts an exemplary daily matchup question 201.

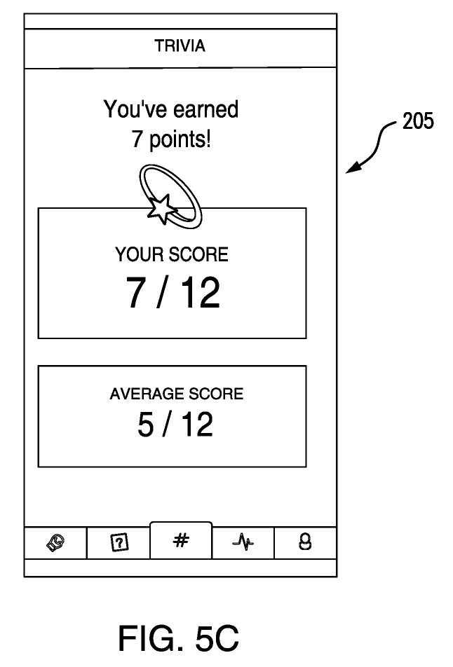

The player will be awarded one reward point for each correct daily matchup 106 answer. Next, the player is prompted to take the daily trivia test 107, consisting in this example of twelve questions that must be answered in one minute. For each correct trivia answer, one reward point is awarded. If the player gets at least one correct answer, he/she may “buy back” another set of ten trivia questions 108 at a cost of 99¢, or the equivalent in reward points. FIGS. 5A-5C depict exemplary trivia test screens, comprising an introductory screen 203, a question screen 204 and an earned points screen 205.

After the player completes the daily matchups 106 and trivia tests 107, his/her reward points are compiled 109. If he/she ranks among the top players on either the reward points leader board or the optional social media leader board 110, he/she will be awarded additional bonus points 111. The game's social media leader component 110 will also list the “trending” hashtags most frequently used in connection with the game and/or its e-commerce sponsors/vendors.

After all reward points and bonus points have been compiled, the app prompts the player to elect to redeem some or all of his points 112. If the player elects to do so, he/she is re-directed to the e-commerce game component 103 to select a gift, after which the player can post updates through the social media links 104 or to his/her profile page 105.

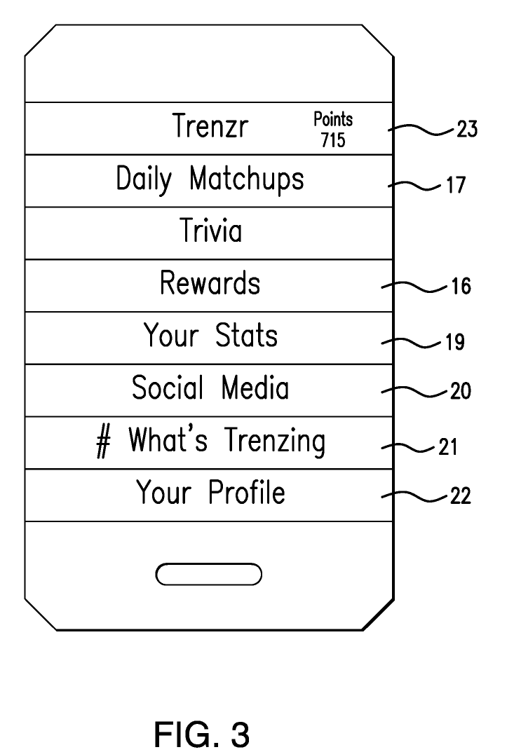

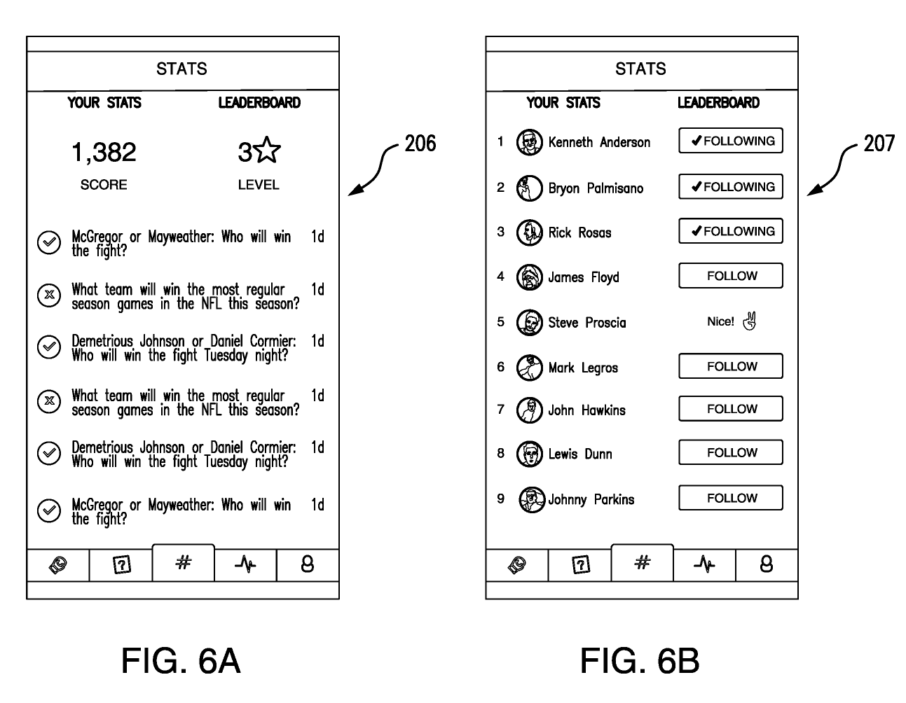

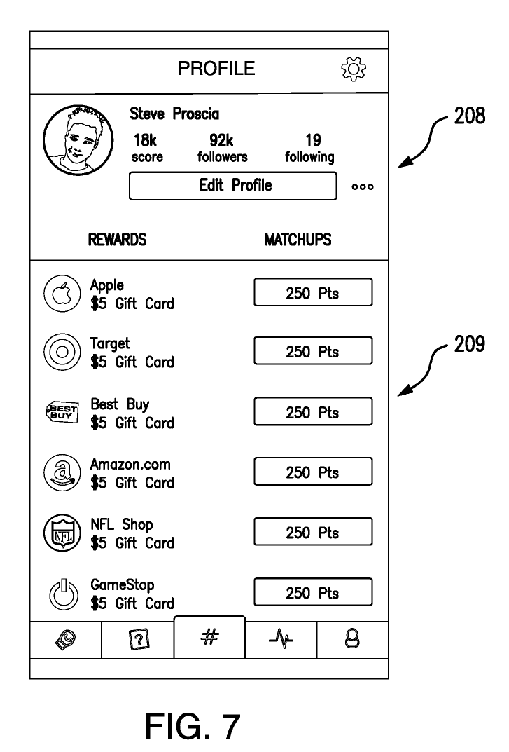

The game system will preferably limit each player to one set of daily matchup 106 and trivia questions 107 per day, subject to optional buy-backs of additional questions 108. After a player exhausts his/her daily quota of questions, the player can return to the app's Main Menu screen, as illustrated in FIG. 3, where he/she can check on the reward status of pending daily matchup questions 17, view his/her current points 23 and stats 19, redeem reward/bonus points 16, make posts to social media 20, update his/her profile page 22 and/or track trending game-related social media hashtags 21. FIGS. 6A and 6B depict exemplary screens for a game participant's statistics 206 and a participants' leader board 207. FIG. 7 shows an exemplary screen for a participant's personal profile 208 and rewards options 209.

Although the preferred embodiments of the present invention have been disclosed for illustrative purposes, those skilled in the art will appreciate that many additions, modifications and substitutions are possible, without departing from the scope and spirit of the present invention, as set forth in the claims that follow.

What is claimed is:

1. A computer-based method of conducting a game among multiple game participants, the method comprising the following steps:
(a) providing to each of the game participants access to a game application software;
(b) use of the game application software by each of the game participants, in conjunction with a computer device, to connect via the internet to a game server;
(c) the game server providing, on a daily basis, to each of the game participants a predictive game component, comprising a daily menu of multiple predictive questions organized in multiple predictive question categories;
(d) each of the game participants selecting each day from the daily menu a selection number of predictive questions, wherein the selection number is the same for each game participant, and wherein the predictive questions thereby selected by each game participant are daily selected questions of the game participant;
(e) each of the game participants giving a predictive answer for each of the game participant's daily selected questions;
the game server determining whether or not each predictive answer is a correct predictive answer;
(g) each of the game participants earning a first reward number of predictive reward points for each correct predictive answer given by the game participant to the game participant's daily selected questions; and
(h) each of the game participants periodically redeeming through the game server the game participant's predictive reward points for one or more reward items.

2. The method according to claim 1, further comprising the following additional steps:
(i) the game server providing, on a daily basis, a trivia game component, comprising a daily trivia contest having a daily trivia list of multiple trivia questions;
(j) each of the game participants having the option to participate in the daily trivia contest by giving a trivia answer to each of the trivia questions on the daily trivia list;
(k) the game server determining whether or not each trivia answer is a correct trivia answer;
(l) each of the game participant's earning a second reward number of trivia reward points for each correct trivia answer; and
(m) each of the game participants periodically redeeming, through the game server, the game participant's trivia reward points for one or more of the reward items.

3. The method according to claim 2, further comprising the following additional steps:
(n) the game server providing a social media game component, in which each of the game participants can earn social media reward points for social media postings promoting the game or a sponsoring business; and
(o) each of the game participants periodically redeeming, through the game server, the game participant's social media reward points for one or more of the reward items.

4. The method according to claim 3, further comprising the following additional steps:
(p) the game server aggregating, on an ongoing basis, for each of the game participants the total of the game participant's predictive rewards, trivia reward points and social media reward points, so as to determine the game participant's cumulative reward points;
(q) the game server providing a leader board game component, in which all of the game participants, or selected groups of some of the game participants, are given a leader board ranking, according to the game participant's cumulative reward points;
(r) each of the game participants earning bonus reward points based on the game participant's leader board ranking; and
(s) each of the game participants periodically redeeming, through the game server, the game participant's bonus reward points for one or more of the reward items.

5. The method according to claim 1, wherein each of the game participants is provided access to the game application software through a centrally hosted mobile SaaS licensed by the game participant as a game subscription and accessed by the game participant through a web browser.

6. The method according to claim 2, wherein each of the game participants is provided access to the game application software through a centrally hosted mobile SaaS licensed by the game participant as a game subscription and accessed by the game participant through a web browser.

7. The method according to claim 3, wherein each of the game participants is provided access to the game application software through a centrally hosted mobile SaaS licensed by the game participant as a game subscription and accessed by the game participant through a web browser.

8. The method according to claim 4, wherein each of the game participants is provided access to the game application software through a centrally hosted mobile SaaS licensed by the game participant as a game subscription and accessed by the game participant through a web browser.

9. The method according to claim 5, wherein the mobile SaaS comprises multiple alternative game components and multiple alternative question categories, and wherein a game sponsor selects one or more of the alternative game components as sponsored game components and one or more of the alternative question categories as sponsored question categories to offer together as a sponsored game subscription to the game participants.

10. The method according to claim 6, wherein the mobile SaaS comprises multiple alternative game components and multiple alternative question categories, and wherein a game sponsor selects one or more of the alternative game components as sponsored game components and one or more of the alternative question categories as sponsored question categories to offer together as a sponsored game subscription to the game participants.

11. The method according to claim 7, wherein the mobile SaaS comprises multiple alternative game components and multiple alternative question categories, and wherein a game sponsor selects one or more of the alternative game components as sponsored game components and one or more of the alternative question categories as sponsored question categories to offer together as a sponsored game subscription to the game participants.

12. The method according to claim 8, wherein the mobile SaaS comprises multiple alternative game components and multiple alternative question categories, and wherein a game sponsor selects one or more of the alternative game components as sponsored game components and one or more of the alternative question categories as sponsored question categories to offer together as a sponsored game subscription to the game participants.

13. The method according to claim 9, wherein the sponsored game components and the sponsored question categories are related to a sponsor brand of products and/or services offered by the game sponsor.

14. The method according to claim 10, wherein the sponsored game components and the sponsored question categories are related to a sponsor brand of products and/or services offered by the game sponsor.

15. The method according to claim 11, wherein the sponsored game components and the sponsored question categories are related to a sponsor brand of products and/or services offered by the game sponsor.

16. The method according to claim 12, wherein the sponsored game components and the sponsored question categories are related to a sponsor brand of products and/or services offered by the game sponsor.

17. The method according to claim 13, wherein the sponsored game subscription provides sponsored reward items related to the sponsor brand.

18. The method according to claim 14, wherein the sponsored game subscription provides sponsored reward items related to the sponsor brand.

19. The method according to claim 15, wherein the sponsored game subscription provides sponsored reward items related to the sponsor brand.

20. The method according to claim 16, wherein the sponsored game subscription provides sponsored reward items related to the sponsor brand.
